(19) United States
(12) Patent Application Publication
(10) Pub. No.: US 2016/0027139 A1
(43) Pub. Date: Jan. 28, 2016

(54) System and Method for Preparing and Implementing Emergency Response Plans

(71) Applicant: Safeguard Risk Solutions LLC, Grove City, OH (US)

(72) Inventor: Gary L. Sigrist, JR., Grove City, OH (US)

(21) Appl. No.: 14/807,701

(22) Filed: Jul. 23, 2015

Related U.S. Application Data
(60) Provisional application No. 62/028,081, filed on Jul. 23, 2014.

(51) Int. Cl. G06Q 50/26; G06Q 10/10

(52) U.S. Cl. CPC G06Q 50/265; G06Q 10/10

(57) ABSTRACT

A system and computer implemented method for implementing an emergency response plan in real time includes the steps of electronically providing an emergency plan flow chart including action items that a user must progress through and complete in real time during an emergency incident, and electronically time stamping the completed action items of the emergency plan flow chart as the user progresses through the emergency plan flow chart during the emergency incident. The user can add notes to the time-stamped competed action items and can save an incident record for the emergency incident record as either an actual emergency incident or a drill.

### CROSS-REFERENCE TO RELATED APPLICATIONS

This application claims the priority benefit of U.S. Provisional application No. 62/028,081 filed on Jul. 23, 2014, the disclosure of which is expressly incorporated herein in its entirety by reference.

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to emergency response plans and, more particularly, to systems and methods for preparing and implementing emergency response plans.

### BACKGROUND OF THE INVENTION

An emergency is an unplanned event that can cause death or significant injuries to persons. Actions taken in initial minutes of an emergency are critical to preventing and/or minimizing death and injuries. A prompt warning to employees to evacuate, shelter, or lockdown saves lives. A call for help to public emergency services with full and accurate information helps a dispatcher send proper responders and equipment. An employee trained to administer first aid or perform CPR is lifesaving. Action by employees with knowledge of building and process systems helps control leaks and minimizes damage to facilities and environment.

In order to ensure that proper actions are taken in an emergency, schools, businesses and the like should, and often must, prepare emergency response plans. In fact, the U.S. Department of Education, the US Department of Homeland Security, and the US Occupational Safety and Health Administration (OSHA) each have standards regarding establishment of emergency response plans. A first step when developing an emergency response plan is to conduct a risk assessment to identify potential emergency scenarios. An understanding of what can happen enables a determination of resource requirements and a development of plans and procedures.

At the minimum, every facility should develop and implement an emergency plan for protecting employees, students, customers, visitors, contractors, and any other persons in the facility. This part of the emergency response plan is typically called “protective actions for life safety” and typically includes building evacuation (“fire drills”), sheltering from severe weather such as tornadoes, “shelter-in-place” from an exterior airborne hazard such as a chemical release and lockdown. Lockdown is protective action when faced with an act of violence.

When an emergency occurs, the first priority should always be life safety. The second priority should be the stabilization of the incident. There are many actions that can be taken to stabilize an incident and minimize potential damage. First aid and CPR by trained employees can save lives. Use of fire extinguishers by trained employees can extinguish a small fire. Containment of a small chemical spill and supervision of building utilities and systems can minimize damage to a building and help prevent environmental damage.

Some severe weather events can be forecast hours before they arrive, providing valuable time to protect a facility. A plan should be established and resources should be on hand, or quickly, available to prepare a facility. The plan should also include a process for damage assessment, salvage, protection of undamaged property and cleanup following an incident. These actions to minimize further damage and business disruption are examples of property conservation

For an emergency response plan to be effective, the plan must be customized to the specific situation/facility, employees must have access and be familiar with the plan, and employees must practice implementation of the plan with emergency simulations. The failure of any one of which can lead to an ineffective plan. Unfortunately, ready-made emergency response plans are often located in a binder/notebook on an office shelf. Accordingly, there is a need for improved systems and methods for preparing and implementing emergency response plans.

### SUMMARY OF THE INVENTION

Disclosed are systems and methods for preparing and implementing emergency response plans. which address one or more issues of the related art. Disclosed is a computer implemented method for implementing an emergency response plan, comprising the steps of electronically providing an emergency plan flow chart including action items that a user must progress through and complete during an emergency incident, electronically time stamping completed action items of the emergency plan flow chart as the user progresses through the emergency plan flow chart during the emergency incident, and allowing the user to save an incident record for the emergency incident record as either an actual emergency incident or a drill.

Also disclosed is an emergency response plan system comprising a processor and memory configured to carry out the steps of electronically providing an emergency plan flow chart including action items that a user can progress through and complete during an emergency incident, electronically time stamping completed action items of the emergency plan flow chart as the user progresses through the emergency plan flow chart during the emergency incident, an allowing the user to save an incident record for the emergency incident as either an actual emergency incident or a drill.

From the foregoing disclosure and the following more detailed description of various preferred embodiments it will be apparent to those skilled in the art that the present invention provides a significant advance in the technology and art of emergency response plans. Particularly significant in this regard is the potential the invention affords for providing customized and easily accessed emergency response plans at a relatively low cost. Additional features and advantages of various preferred embodiments will be better understood in view of the detailed description provided below.

### BRIEF DESCRIPTION OF THE DRAWINGS

These and further features of the present invention will be apparent with reference to the following description and drawings.

FIG. 1 is a block diagram of an emergency response plan system according to the present invention.

FIG. 1A is schematic view of an exemplary user mobile device of the system of FIG. 1.

FIG. 1B is schematic view of an exemplary administrator computer of the system of FIG. 1.

FIG. 1C is schematic view of an exemplary service provider server of the system of FIG. 1.

FIG. 2 is a screenshot of a login page of a web-based platform of the emergency response plan system of FIG. 1.

FIG. 3 is a screenshot of a district administrative panel page of a web-based platform of the emergency response plan system of FIG. 1.

FIG. 4 is a screenshot of a collections available page of a web-based platform of the emergency response plan system of FIG. 1.

FIG. 5 is a screenshot of a title edit page of a web-based platform of the emergency response plan system of FIG. 1.

FIG. 6 is a screenshot of a groups page of a web-based platform of the emergency response plan system of FIG. 1.

FIG. 7 is a screenshot of a users page of a web-based platform of the emergency response plan system of FIG. 1.

FIG. 8 is a screenshot of a viewable collections page of a web-based platform of the emergency response plan system of FIG. 1.

FIGS. 9 to 14 are screenshots of pages of a web-based platform of the emergency response plan system of FIG. 1 during a response plan walk through of flow chart.

FIG. 15 is a screenshot of a page of a web-based platform of the emergency response plan system of FIG. 1 showing logging of flow chart responses.

FIG. 16 is a screenshot of a page of a web-based platform of the emergency response plan system of FIG. 1 showing a note added to a log.

FIG. 17 is a screenshot of an evacuation closure page of a web-based platform of the emergency response plan system of FIG. 1.

FIG. 18 is a screenshot of an evacuation completion page of a web-based platform of the emergency response plan system of FIG. 1 wherein an evacuation is logged as an actual incident or a drill.

It should be understood that the appended drawings are not necessarily to scale, presenting a somewhat simplified representation of various preferred features illustrative of the basic principles of the invention. The specific design features of the emergency response plan systems and methods as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. All references to direction and position, unless otherwise indicated, refer to the orientation of the systems and methods illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the emergency response plan systems and methods disclosed herein. The following detailed discussion of various alternative and preferred embodiments will illustrate the general principles of the invention in the form of systems ad methods configured for use by a school. Other embodiments suitable for other applications will be apparent to those skilled in the art given the benefit of this disclosure such as, for example, retail stores, office buildings, manufacturing plants, warehouses, hotels, hospitals, churches, living communities, government buildings, military facilities, stadiums, arenas, other public venues, and the like.

Illustrated is a web-based platform for a school district that is prepopulated with an all-hazards emergency response plan based on best practices of the industry and the latest standards of the U.S. Department of Education and the U.S. Department of Homeland Security. The illustrated web-based platform permits the using school district to customize the emergency response plan to prepare and store customized emergency response plans for each building of its school district. The illustrated platform also provides customized emergency plan flow charts that a user can progress through step-by-step during an emergency incident (either actual or drill) and the user can add notes to time stamped items as the user progresses through the flow charts during the incident. Logs of each emergency incident are tagged as actual emergency incidents or drills and can later be viewed by command center personnel for emergency response evaluation. The illustrated web-based platform stores the emergency response plans, flow charts, supplemental materials, etc. on the web via cloud storage so that authorized users of the school district can view the emergency response plans and other materials with any electronic device having Internet access, such as, for example, desktop computers, laptops, note book computers, tablet computers, web book computers, smart phones, and the like. The illustrated platform allows users to upload supplemental material specific to the school district. Full views of the emergency flow chart and supplemental materials are also provided.

The illustrated platform allows the emergency response plan administrator of the school district to establish and maintain login privileges for each user of the system to control access to the emergency response plans and other information. Some users, having high level roles, can access and step through the emergency plan flow charts during an incident (either actual or drill) and add notes to the time stamped items as the user progresses through the flow charts during the incident. other users, having lower roles, can only access the emergency response plan and supplemental materials for their building.

A mobile application works in connection with the illustrated web platform so that the administrator can immediately push the latest version of the emergency response plan out to all users of the system upon making an update the plan. This information is cached on the user's mobile electronic device so that the emergency response plan is available for viewing by the user even in the event that the user has no cell service or internet access. Thus, all users such as, for example, administrators, incident commanders, teachers, employees, school bus drivers, have instant and continuous access to the most update information on their mobile electronic device.

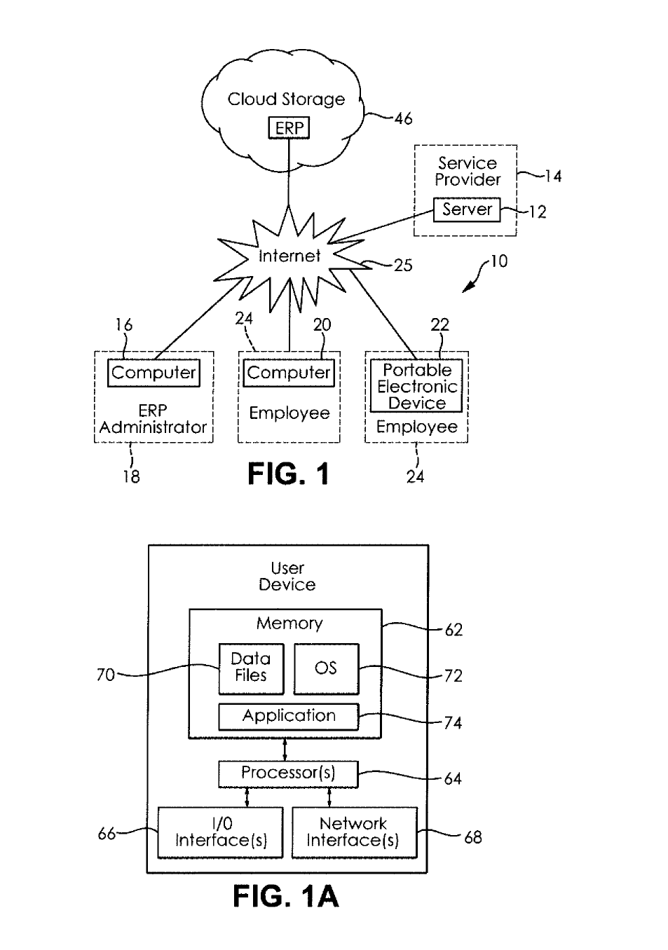

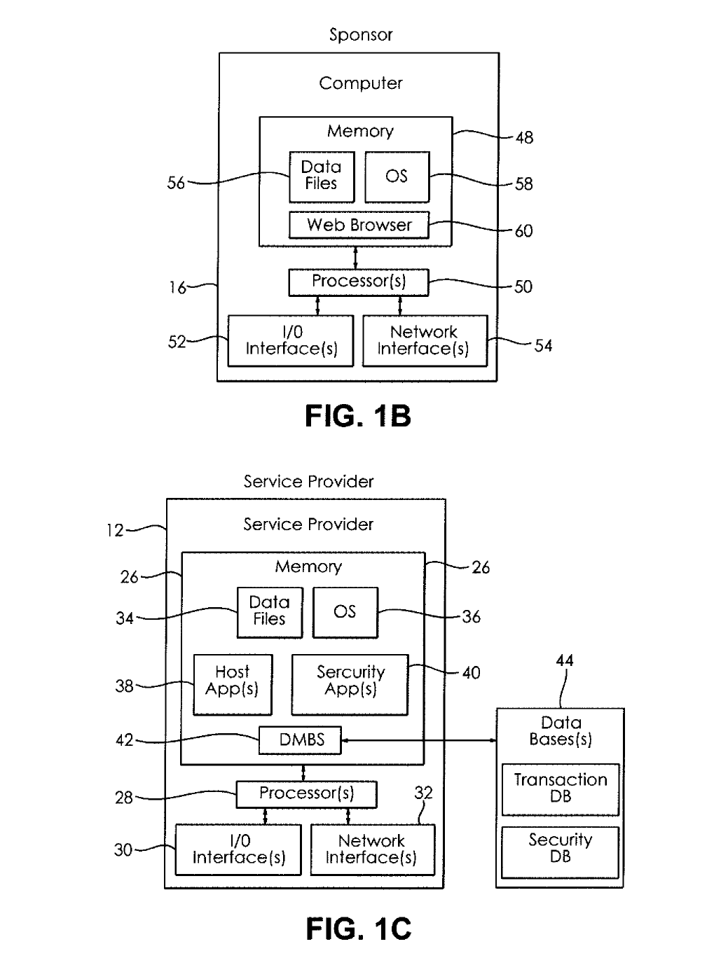

Referring now to the drawings, FIG. 1 illustrates an emergency response plan system 10 according to the present invention. The illustrated emergency response plan system 10 includes at least one server 12 located at a service provider 14 and including computer software for carrying out a method for preparing and implementing an emergency response plan according to the present invention, at least one administrator computer 16 used by an administrator 18 to access the server 12, and a plurality user computers 20 and/or user portable electronic devices 22 with which users 24 such as school administrators, employees, teachers, bus drivers, students, etc. access the server 12. It is noted that while the illustrated software is provided by the service provider 14 as software as a service, the software can alternatively can be located at any other suitable location such as a school server or computer network. The term “server” is used in the specification and claims to mean a computer configured to manage, store, send and process data 24-hours a day. The term “computer” is used in the specification and claims to mean any electronic device that can suitably communicate via a computer network including, but not limited to, desktop computers, laptop computers, notebook computers, tablet computers, smart phones, personal digital assistants (PDAs), digital cameras, mp3 players, video game systems, messaging systems, video players, smart televisions, and the like. The terms “portable electronic device” and “mobile device” are used in the specification and claims to mean a handheld electronic device that utilizes rechargeable batteries as a power source and that that can suitably communicate with event system server via the computer network including, but not limited to, smart phones, personal digital assistants (PDAs), mp3 or other music players, video game players, messaging systems, tablet computers, notebook computers, and the like

The illustrated service provider server 14, the illustrated administrative computer 18, and the illustrated user computer 20 a mobile devices 22 are in electronic communication with one another via a communication system 25. The illustrated communication system 25 is a computer network such as the Internet but any other suitable communication system can alternatively be utilized such as, for example, an intranet, any other type of network of computers, and the like.

The illustrated service provider server or computer 12 includes memory 26, at least one processor or central processing units (CPU) 28 in communication with the memory 26, one or more input/output (IO) interfaces 30 in communication with the processor 28, and at least one network interface 32 in communication with the processor 28, all of which is configured to carry out the functions and steps described herein (best shown in FIG. 1C). The illustrated memory 26 stores data files 34, an operating system (OS) 36, host applications 38 for communications with web browsers and mobile applications, security applications 40 for limiting access to authorized users, and a database management system 42 for interfacing with databases 44 having stored information. It is noted that any other suitable information and/or software can be stored in the processor 28 and/or the memory 26. The illustrated databases 44 are separate from the service provider server or computer 12 but it is noted that the databases 44 can alternatively be integrated with the service provider server or computer 12. The illustrated databases 44 are located at the service provider 14 and/or a cloud location 46 but it is noted that the databases 44 can alternatively be located at any other suitable location and/or be of any other suitable type. The illustrated databases 44 include a transaction database and a security database but any other suitable types of databases can alternatively or additionally be utilized. The at least one processor 28 can be of any suitable type. The at least one IO interface 30 can be of any suitable type such as a keyboard, a mouse, a track ball, a touch pad, a camera, a speaker, a monitor, a printer, a modem, a disk drive and the like. The network interface 32 can be of any suitable type such as, for example, a network interface card, software simulating a network card, and the like. The illustrated processor 28 and memory 26 are programmed with computer software for facilitating emergency response plans including providing a web portal for interfacing with the administrative computer 16 and the user computers 20 and mobile devices 22 as described in more detail hereinafter.

The illustrated service provider server or computer 12 is located at the service provider 14 and can be accessed by both administrators 18 and users 24 via the communication system 25. It is noted that while the illustrated software is provided by the service provider 14 to the administrator 18 as software as a service (SaaS), the software can alternatively be provided in other suitable manners such as provided by an administrative server or computer 16, an activity or event location server or computer, and the like. It is also noted that while the illustrated system 10 shows a single administrator 18, it should be appreciated that the service provider 14 typically provides such SaaS services to a plurality of different administrators in the form of school districts, schools, businesses, organizations, and the like. It is further noted that the service provider server 12 is not necessarily physically located at physical facilities of the service provider 14. In many instances the system 10 is cloud based.

The illustrated administrator computer 16 includes memory 48, at least one processor or central processing units (CPU) 50 in communication with the memory 48, one or more input/output (IO) interfaces 52 in communication with the processor 50, and at least one network interface 54 in communication with the processor 50, all of which is configured to carry out the functions and steps described herein (best shown in FIG. 1B). The illustrated memory 48 stores data files 56, an operating system (OS) 58, and a web browser 60. It is noted that any other suitable information and/or software can be stored in the processor 50 and/or memory 48. The at least one processor 50 can be of any suitable type. The at least one IO interface 52 can be of any suitable type such as a keyboard, a mouse, a track ball, a touch pad, a camera, a speaker, a monitor, a printer, a modem, a disk drive and the like. The network interface 54 can be of any suitable type such as, for example, a network interface card, software simulating a network card, and the like. The illustrated processor 50 and memory 48 are programmed with the web browser 60 for communicating with the web portal of the service provider server 12 as described in more detail hereinafter.

The illustrated administrator computer 16 is located at the administrator 18 such as, for example, a school building of the administrator 18 but it is noted that the administrator computer 16 can be located at any other suitable location such as, for example, an office building, home, and the like. It is noted that the administrator computer 16 can be a desktop computer or a mobile computer. It is further noted that that while the illustrated system 10 shows a single administrator computer 16, it should be appreciated that there is typically a plurality administrator computers 16 at one or more locations.

The illustrated user computer 20 are essentially the same as described above for the administrator computer 16 but any other suitable computer can be utilized. The illustrated user computer 20 is located at a location of the user 24 such as, for example, a school building of the administrator 18 but it is noted that the user computer 16 can be located at any other suitable location such as, for example, an office building, home, and the like. It is noted that that while the illustrated system 10 shows a single user computer 20, it should be appreciated that there is typically a larger plurality user computers 20 at one or more locations.

The illustrated user mobile devices 20 each include memory 62, at least one processor or central processing units (CPU) 64 in communication with the memory 62, one or more input/output (IO) interfaces 66 in communication with the processor 64, and at least one network interface 68 in communication with the processor 62, all of which is configured to carry out the functions and steps described herein (best shown in FIG. 1A). The illustrated memory 62 stores data files 70, an operating system (OS) 72, and a mobile application 74. It is noted that any other suitable information and/or software can be stored in the processor 64 and/or memory 66. The at least one processor 64 can be of any suitable type. The at least one IO interface 66 can be of any suitable type such as a keyboard, a mouse, a track ball, a touch pad, a camera, a speaker, a touch screen, and the like. The network interface 68 can be of any suitable type such as, for example, a network interface card, software simulating a network card, and the like. The illustrated processor 64 and memory 62 are programmed with the mobile app or application 74 for communicating with the web portal of the service provider server 12 as described in more detail hereinafter. The terms “mobile app” and “mobile application” are used in the specification and claims to mean a type of application software designed to run on a mobile device to provide users with similar services to those accessed on personal computers.

The illustrated user mobile devices 22 are typically physically located with the users 24. It is noted that that while the illustrated system 10 shows a single users 24 having a mobile device 22, it should be appreciated that there is typically a large plurality of users 22 having mobile devices 24.

The illustrated emergency response plan system software resides at the service provider server 12 and is accessible to school administrators and other users via the communication system 25 through portal or login page. It is also noted that the service provider server 12 is not necessarily located at physical facilities of the service provider. In most instances the system is cloud based.

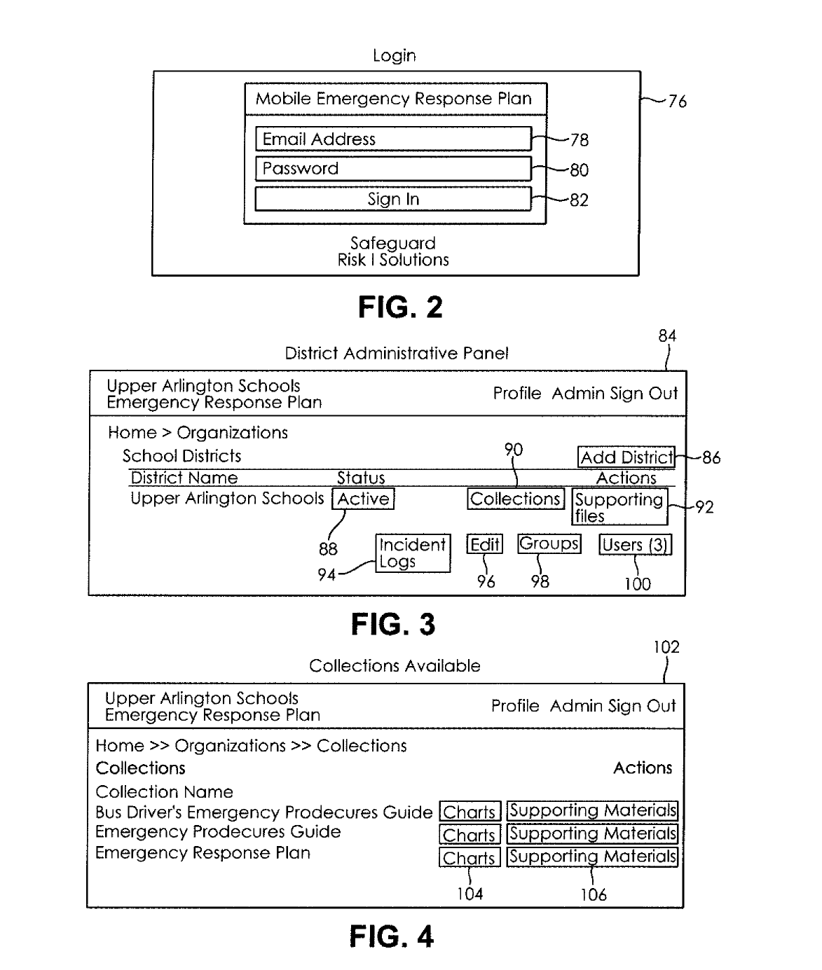

FIG. 2 shows a screenshot of a login page 76 of the illustrated web-based platform. The illustrated login page 76 includes fields 78, 80 for an administrator 18 and/or a user 24 to input a user name and a password to gain access to the web based platform. The illustrated login page 76 also includes a link in the form of a sign-in button 82 for activation by the administrator 18 when information has been input into the fields 78, 80 and the administrator 18 desires to complete the login process. It is noted that the link can alternatively be of other suitable type. As discussed above, the administrators 18 and the users 24 have access of varying levels as determined by the system administrator 18. It is noted that the login page can alternatively have any other suitable configuration, information, and/or fields/links.

FIG. 3 shows a screenshot of a district administrative panel page 84 of the illustrated web-based platform. The illustrated district administrative panel page 84 displays a list of schools administered by the administrator 18 and permits the district administrator 18 to add schools to the list and to delete schools from the list. The illustrated district administrative panel page 84 includes a link in the form of an add/delete button 86 for activation by the administrator 18 when they would like to add or delete a school on the list. It is noted that the link can alternatively be of other suitable type. For each school on the list, there is a status indication 88 as to whether the school is active and provides actions for the school or is inactive. The for each school on the list there is also a plurality of links including a collections link in the form of a button 90, a supporting files link in the form of a button 92, an incident logs link in the form of a button 94, a groups link in the form of a button 96, an edit link in the form of a button 98, and an users link in the form of a button. It is noted that the links can alternatively be of other suitable type. It is noted that the district administrative panel can alternatively have any other suitable configuration, information, and/or links.

FIG. 4 shows a screenshot of a collections available page 102 of the illustrated web-based platform. The illustrated collections available page 102 displays a listing of available information collections and permits the district administrator 18 to add and delete available collections. The illustrated information collections are a Bus Driver Procedures Guide, an Emergency Procedures Guide, and an Emergency Response Plan, but it is noted that any other suitable quantity or type of collections can be included. For each collection on the list, there are actions for the collection. The illustrated actions are a link to charts in the form of a button 104 and a link to supporting materials in the form of a button 106. It is noted that the links can alternatively be of other suitable type. It is noted that the collections available page 102 can alternatively have any other suitable configuration, information, and/or links.

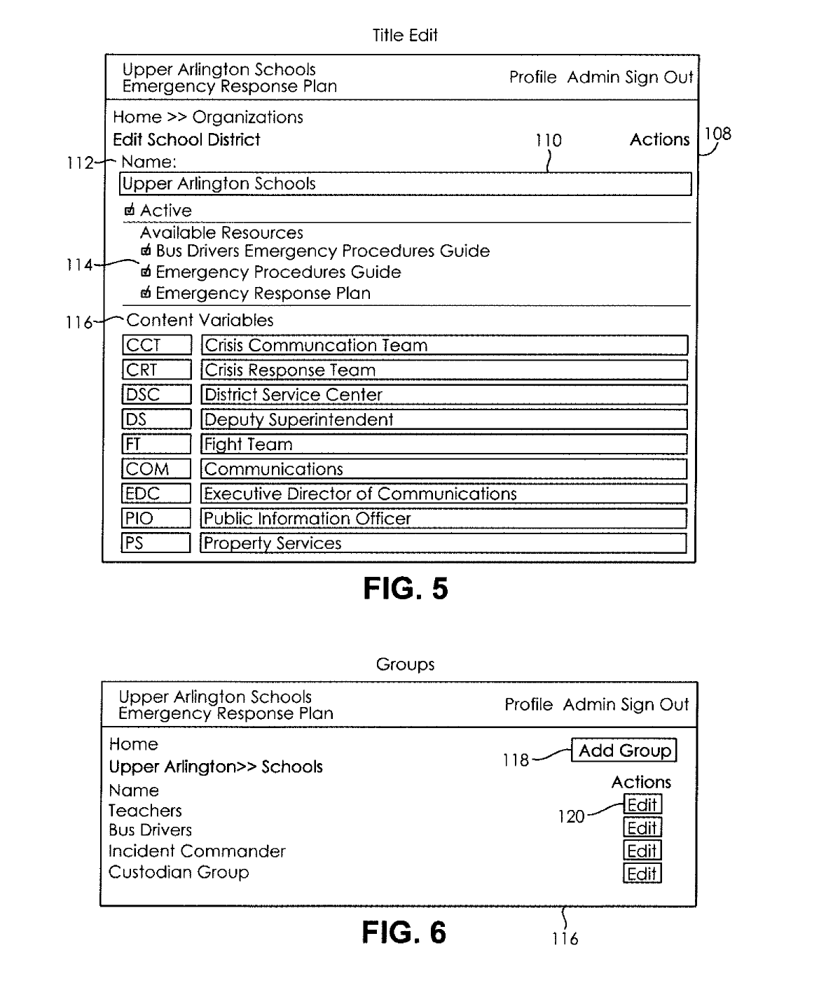

FIG. 5 shows a screenshot of an edit page 108 of the illustrated web-based platform. The illustrated edit page 108 permits the administrator 18 to edit the name, available resources and content variables for each school. The illustrated edit page 108 includes a field 110 for entering the school name, a field for indicating if the school is active 112, and fields 114 for indicating if particular resources are available for the school. The illustrated fields 114 include (1) a bus driver's emergency procedures guide, (2) an emergency procedures guide, and (3) an emergency response plan. The illustrated edit page 108 includes links in the form of buttons 116 for inputting content variables for the school including (1) the crisis communication team (CCT), (2) the crisis response team (CRT), (3) the district service center (DSC), (4) the deputy superintendent (DS), (5) the flight team (FT), (6) Communications (COM), (7) the executive director of communication EDC), (8) the public information officer (PIO), and (9) the property services (PS). It is noted that the links can alternatively be of other suitable type. It is noted that the title edit page 108 can alternatively have any other suitable configuration, information, and/or fields/links.

FIG. 6 shows a screenshot of a groups page 116 of the illustrated web-based platform. The illustrated groups page 116 shows a listing of groups of types or categories of users 24. The illustrated groups are teachers, bus drivers, incident commander, and custodians but any other suitable groups can be utilized. The illustrated groups page 116 includes a link in the form of an add/delete button 118 for activation by the administrator 18 when they would like to add or delete a group on the list. Each group can be edited by selecting a link in the form of an edit button 120. It is noted that the links can alternatively be of other suitable type. It is noted that the groups page can alternatively have any other suitable configuration, information, and/or fields/links.

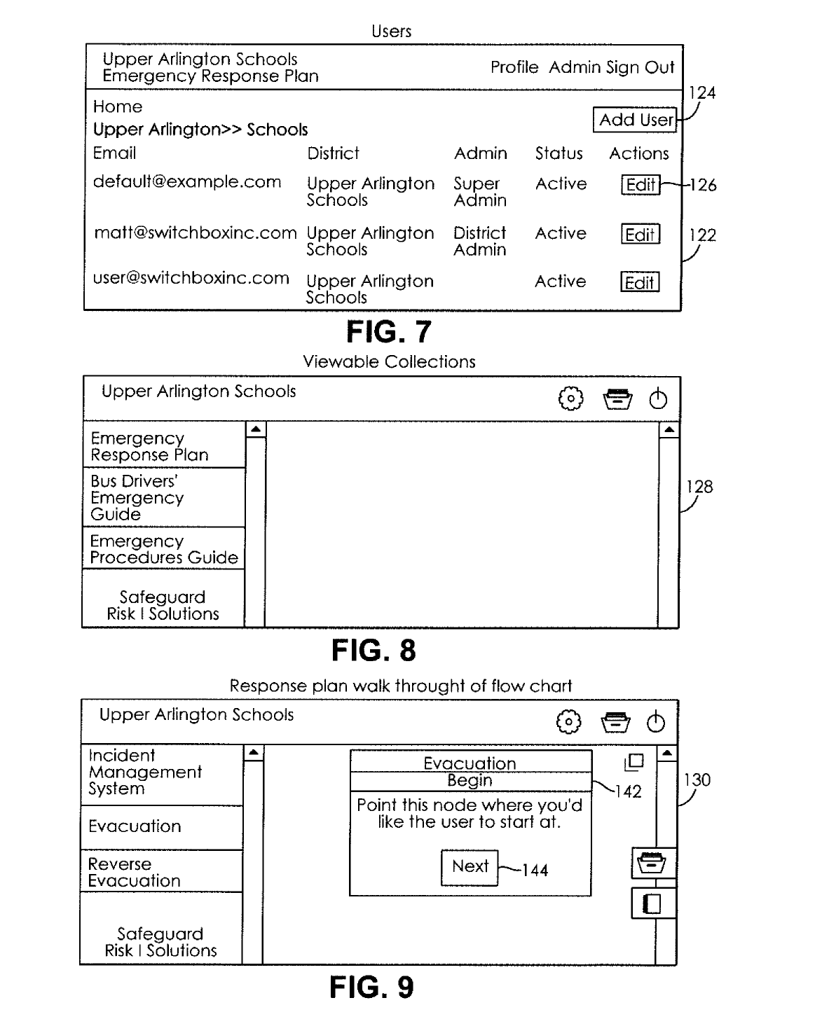

FIG. 7 shows a screenshot of a users page 122 of the illustrated web-based platform. The illustrated users page 122 has a listing of users identified by email address and associated information including the district, the administrator's title, and status for each user. The illustrated users page 122 includes a link in the form of an add/delete button 124 for activation by the administrator 18 when they would like to add or delete a user on the list. Each user on the list can be edited by selecting a link in the form of an edit button 126. It is noted that the links can alternatively be of other suitable type. It is noted that the users page 122 can alternatively have any other suitable configuration, information and/or fields/links.

FIG. 8 shows a screenshot of a viewable collections page 128 of the illustrated web-based platform. The illustrated viewable collections page 128 has a listing of collections that can be viewed by the particular logged-in user. The illustrated viewable collections for the user are a Bus Driver Procedures Guide, an Emergency Procedures Guide, and an Emergency Response Plan, but it is noted that any other suitable quantity or type of collections can be included. My clicking on an item on the list, the item is displayed to the user for viewing. It is noted that the viewable collections page 128 can alternatively have any other suitable configuration, information, and/or fields/links.

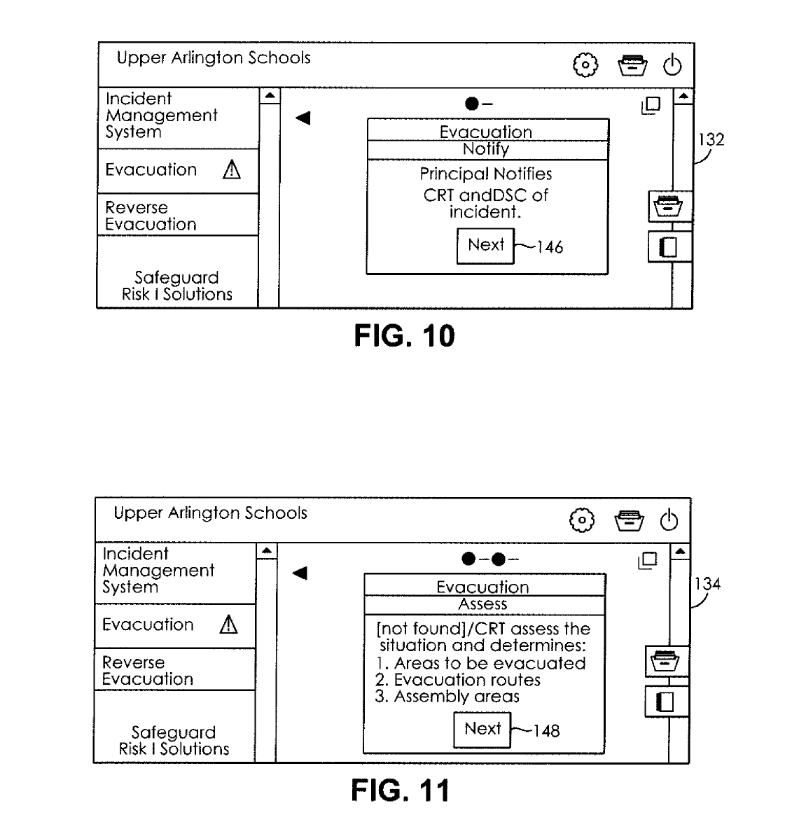

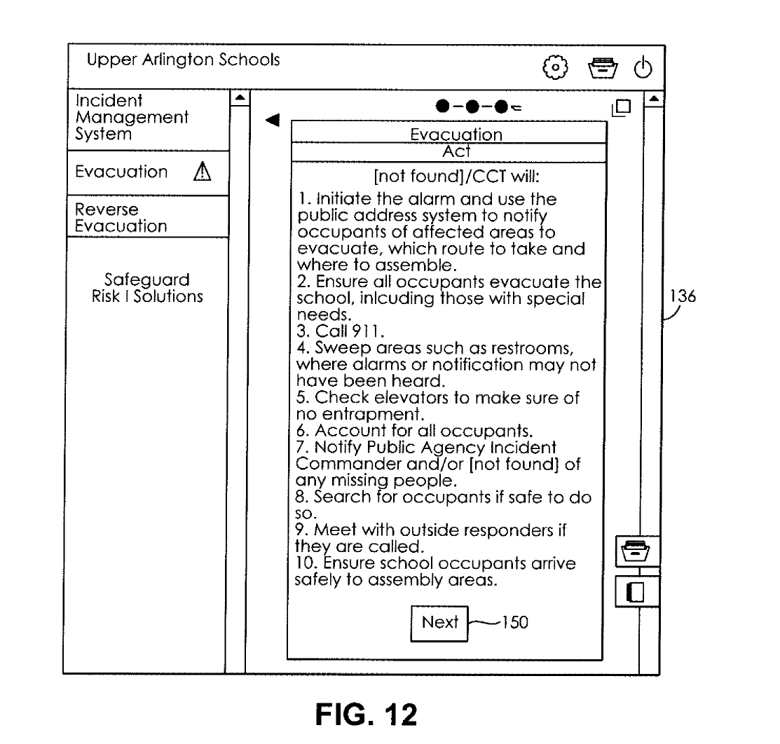

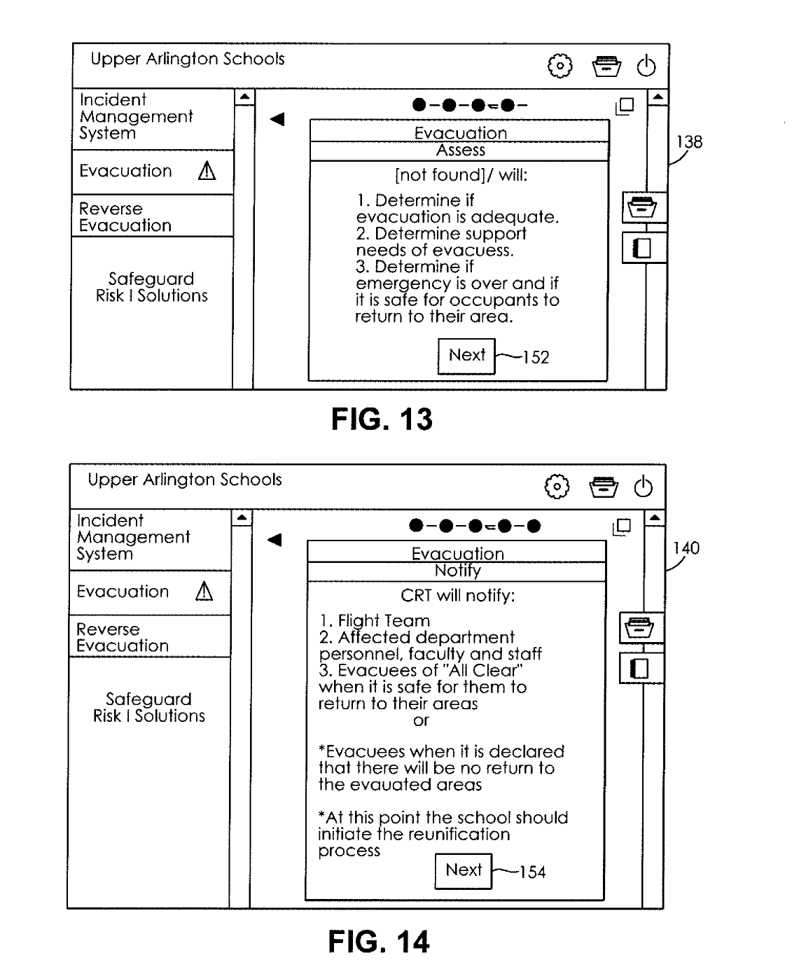

FIGS. 9 to 14 show screenshots of a series of evacuation pages 130 to 140 of the illustrated web-based platform during a walk-through of flow chart for an emergency incident. The illustrated evacuation pages 130 to 140 collectively display a flow chart so that a user can progress through the flow chart in real-time during an emergency incident to guide them through required actions for the emergency response plan in order to ensure that all necessary steps are taken. The illustrated first evacuation page 130 includes a link in the form of a begin button that when selected permits the user to identify where they want to start in the flow chart. The illustrated first evacuation page 130 includes a link in the form of a next button 144 that when selected permits the user to identify they want to go to the next page of the flow chart. It is noted that the links can alternatively be of other suitable type. The illustrated second evacuation page 132 displays a notification step wherein all parties that must be notified of the emergency incident are displayed. The illustrated second evacuation page 132 includes that the crisis response team (CRT) and the district service center (DSC) must be notified of the emergency incident and that the notification should be made by the school principal. The illustrated second evacuation page 132 includes a link in the form of a next button 146 that when selected permits the user to identify they want to go to the next page of the flow chart. The illustrated third evacuation page 134 displays a first assess step wherein items to be assessed before evacuation for the emergency incident are displayed. The illustrated third evacuation page 134 includes that the crisis response team (CRT) should assess and determine (1) the areas to be evacuated, (2) evacuation routes, and (3) assembly areas. The illustrated third evacuation page 134 includes a link in the form of a next button 148 that when selected permits the user to identify they want to go to the next page of the flow chart. The illustrated fourth evacuation page 136 displays an act step wherein items to be performed for the emergency incident are displayed. The illustrated fourth evacuation page 136 includes that the crisis communication team (CCT) should take the following actions (1) initiate the alarm and use the public address systems to notify occupants of effected areas that they need to evacuate, the evacuation routes to be taken, and the assembly areas, (2) ensure that all occupants evacuate the school including those with special needs, (3) call 911, (4) sweep areas such as restrooms where the evacuation notice may not have been heard, (5) check elevators to make sure of no entrapment, (6) account for all occupants, (7) notify Public agency incident Commander of any missing persons, (8) search for missing occupants if safe to do so, (9) meet with outside responders if they are called to scene, and (10) ensure school occupants safely arrive at assembly areas. The illustrated fourth evacuation page 136 includes a link in the form of a next button 150 that when selected permits the user to identify they want to go to the next page of the flow chart. The illustrated fifth evacuation page 138 displays a second assess step wherein items to be assessed after evacuation for the emergency incident are displayed. The illustrated fifth evacuation page 138 includes that the crisis response team (CRT) should assess and determine (1) if the evacuation was adequate, (2) support needs of evacuees, and (3) if the emergency is over and if it is safe for evacuees to return to their area. The illustrated fifth evacuation page 138 includes a link in the form of a next button 152 that when selected permits the user to identify they want to go to the next page of the flow chart. The illustrated sixth evacuation page 140 displays a notification step wherein persons to be notified for the emergency incident are displayed. The illustrated sixth evacuation page 140 includes that the crisis response team (CRT) should notify (1) the flight team, (2) affected departmental personnel, faculty, and staff, and (3) evacuees of either an “all clear when it is safe to return to their areas or that there will be no return to the evacuated areas. The illustrated sixth evacuation page 140 includes a link in the form of a next button 154 that when selected permits the user to identify they want to go to the next page of the flow chart. It is noted that the links can alternatively be of other suitable type. It is noted that the flow chart pages can alternatively have any other suitable form.

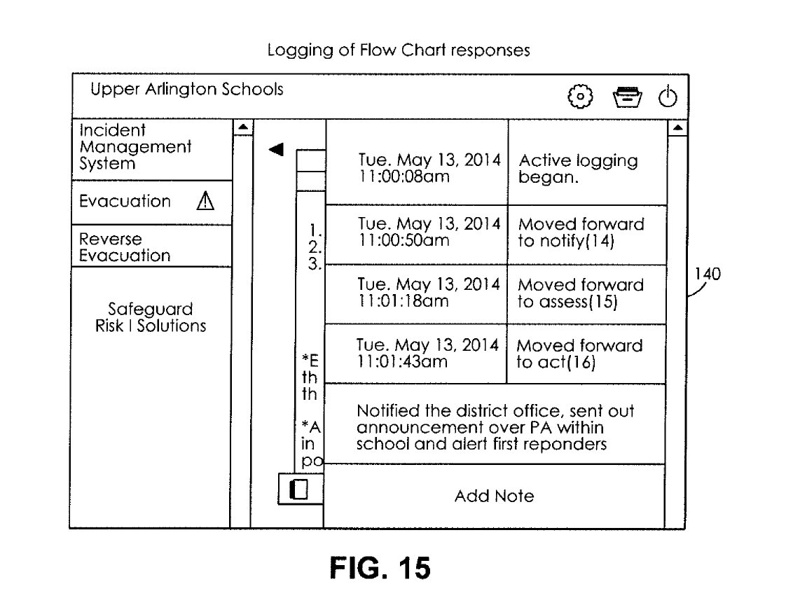

FIG. 15 shows a screenshot of the sixth evacuation page 140 of the illustrated web-based showing the logging of flow chart responses. As the user walks through the incident flow chart, they are prompted to enter responses or completions of the steps that are automatically time-stamped and saved. It is noted that the responses and time stamps can alternatively have any other suitable form.

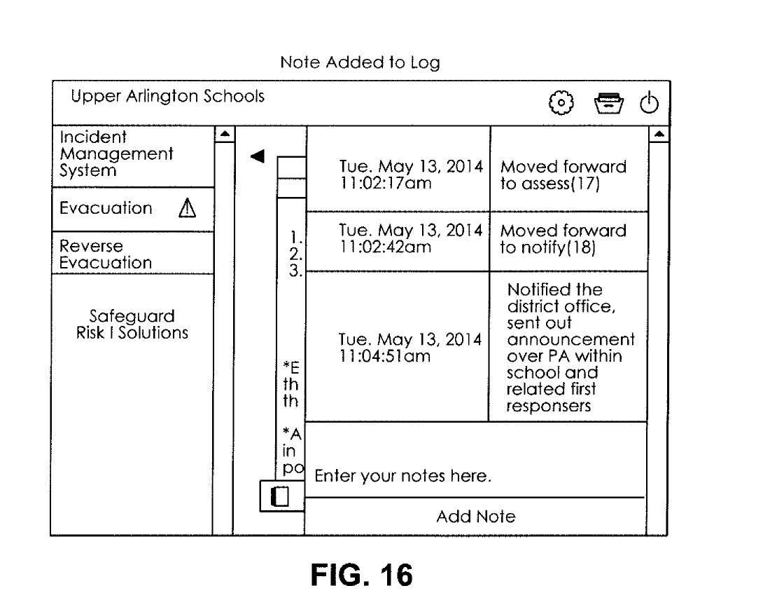

FIG. 16 shows a screenshot of the sixth evacuation page 140 of the illustrated web-based platform showing a notes added to a log entry. The user can add notes to any of the time-stamped events as they walk through the evacuation flow chart. It is noted that the notes can alternatively have any other suitable form.

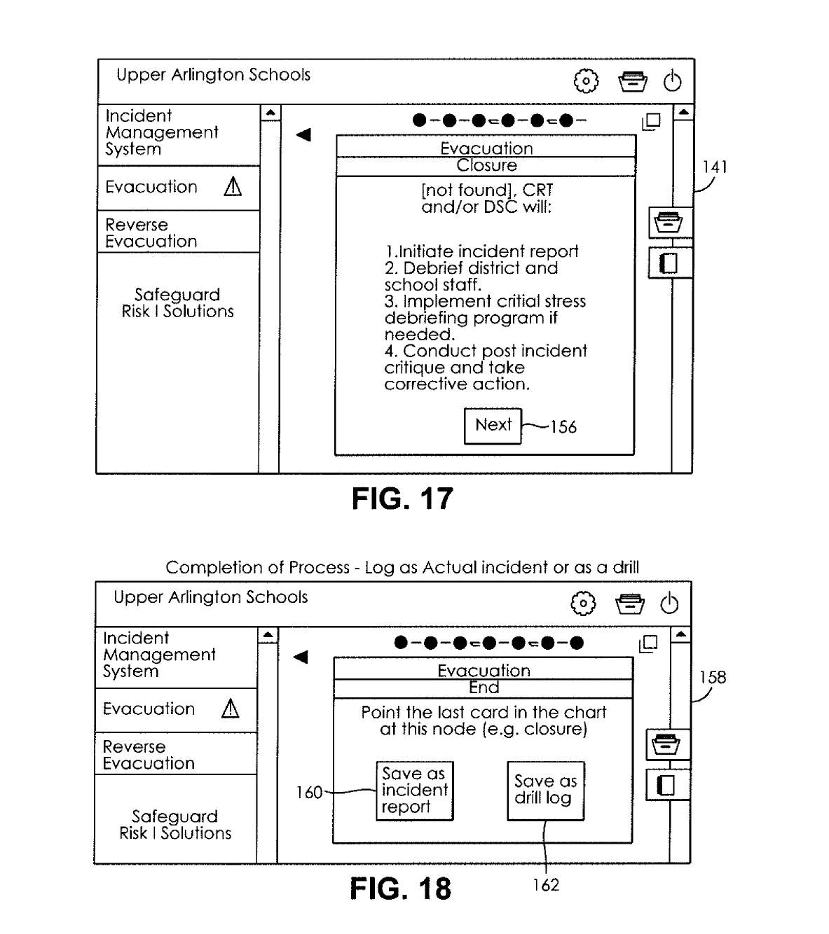

FIG. 17 shows a screenshot of the seventh evacuation page 141 of the illustrated web-based platform wherein items required to close the emergency incident are displayed. The illustrated seventh evacuation page 141 shows a list of actions to follow the completion of the evacuation or incident log to be completed by the crisis response team (CRT) and/or the district service center. The illustrated list includes the actions of (1) initiate incident report, (2) debrief district and school staff, (3) implement critical stress debriefing program if needed, and (4) conduct post incident critique and take corrective action but it is noted that any other suitable actions can be alternatively be included. The illustrated seventh evacuation page 141 includes a link in the form of a next button 156 that when selected permits the user to identify they want to go to the next page of the flow chart. It is noted that the links can alternatively be of other suitable type. It is noted that the evacuation closure page can alternatively have any other suitable configuration and/or information.

FIG. 18 shows a screenshot of an evacuation completion page 158 of the illustrated web-based platform. The illustrated evacuation completion page 150 has a pair of links in the form of buttons 160, 162 to save the evacuation or incident log as either an actual incident or to save the evacuation or incident log as a drill. It is noted that the links can alternatively be of other suitable type. It is noted that the evacuation completion can alternatively have any other suitable configuration and/or information.

Any of the features or attributes of the above the above described embodiments and variations can be used in combination with any of the other features and attributes of the above described embodiments and variations as desired.

It is apparent from the above detailed description of preferred embodiments of the present invention, that the illustrated emergency response plan systems and methods (1) enable the assigned “incident commander” to follow the emergency response plan approved by first responders to reduce risk and liability for the school district; (2) provides employees mobile access to the most current, up-to-date emergency response plan on their computer and/or personal electronic device; (3) meets every U.S. Department of Education and U.S. homeland Security Department standard; (4) provides the ability to send plan updates to government agencies if needed; (5) allows camera, video or voice recorder for additional report options; and (6) eliminates costly printing or manual updating of plans.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A computer implemented method for implementing an emergency response plan, comprising the steps of:
electronically providing an emergency plan flow chart including action items that a user must progress through and complete during an emergency incident;
electronically time stamping completed action items of the emergency plan flow chart as the user progresses through the emergency plan flow chart during the emergency incident; and
allowing the user to save an incident record for the emergency incident record as either an actual emergency incident or a drill.

2. The computer implemented method according to claim 1, further comprising the step of allowing the user to electronically record notes associated with the time-stamped completed action items.

3. The computer implemented method according to claim 1, wherein the emergency plan flow chart includes a notification step wherein all parties that must be notified of the emergency incident are displayed.

4. The computer implemented method according to claim 3, wherein the emergency plan flow chart includes a first assess step wherein items to be assessed before evacuation for the emergency incident are displayed

5. The computer implemented method according to claim 4, wherein the emergency plan flow chart includes an act step wherein items to be performed for the emergency incident are displayed.

6. The computer implemented method according to claim 5, wherein the emergency plan flow chart includes a second assess step wherein items to be assessed after evacuation for the emergency incident are displayed.

7. The computer implemented method according to claim 6, wherein the emergency plan flow chart includes a notification step wherein persons to be notified for the emergency incident are displayed.

8. The computer implemented method according to claim 7, wherein the emergency plan flow chart includes a closure step wherein items required to close the emergency incident are displayed.

9. An emergency response plan system comprising a processor and memory configured to carry out the steps of:
electronically providing an emergency plan flow chart including action items that a user can progress through and complete during an emergency incident;
electronically time stamping completed action items of the emergency plan flow chart as the user progresses through the emergency plan flow chart during the emergency incident; and
allowing the user to save an incident record for the emergency incident as either an actual emergency incident or a drill.

10. The emergency response plan system according to claim 9, further comprising the step of allowing the user to electronically record notes associated with the time-stamped completed action items.

11. The emergency response plan system according to claim 9, wherein the emergency plan flow chart includes a notification step wherein all parties that must be notified of the emergency incident are displayed.

12. The emergency response plan system according to claim 11, wherein the emergency plan flow chart includes a first assess step wherein items to be assessed before evacuation for the emergency incident are displayed

13. The emergency response plan system according to claim 12, wherein the emergency plan flow chart includes an act step wherein items to be performed for the emergency incident are displayed.

14. The emergency response plan system according to claim 13, wherein the emergency plan flow chart includes a second assess step wherein items to be assessed after evacuation for the emergency incident are displayed.

15. The emergency response plan system according to claim 14, wherein the emergency plan flow chart includes a notification step wherein persons to be notified for the emergency incident are displayed.

16. The emergency response plan system according to claim 15, wherein the emergency plan flow chart includes a closure step wherein items required to close the emergency incident are displayed.
